(19) United States
(12) Patent Application Publication
(10) Pub. No.: US 2022/0048132 A1
(43) Pub. Date: Feb. 17, 2022

(54) PATTERN EDITOR FOR GENERATING FUNCTIONAL TEXTURES

(71) Applicant: Standex International Corporation, Salem, NH (US)

(72) Inventors: Francesco IORIO, Toronto (CA); Ian Ross AMELINE, Toronto (CA); Tasso Anastasios KARKANIS, Toronto (CA); Michael Wenhan TAO, Toronto (CA); Massimiliano MORUZZI, Rockford, IL (US); Aaron Michael SZYMANSKI, Toronto (CA)

(21) Appl. No.: 17/400,025

(22) Filed: Aug. 11, 2021

Related U.S. Application Data
(60) Provisional application No. 63/065,459, filed on Aug. 13, 2020.

(51) Int. Cl. B23K 26/046; B23K 26/359; B23K 26/352

(52) U.S. Cl. CPC B23K 26/046; B23K 26/355; B23K 26/359

(57) ABSTRACT

A computer-implemented method for generating laser engraving instructions for performing a patterning process on a workpiece surface includes receiving a first input value indicating a first laser-pulse pattern and a second input value for a laser parameter associated with a laser-engraving system; and generating a machine-command sequence for the laser-engraving system based on the first input value and the second input value.

### CROSS-REFERENCE TO RELATED APPLICATIONS

This application claims priority benefit of the United States Provisional patent application titled, “FUNCTIONAL TEXTURES PATTERN EDITOR,” filed on Aug. 13, 2020 and having Ser. No. 63/065,459. The subject matter of this related application is hereby incorporated herein by reference.

### BACKGROUND

### Field of the Various Embodiments

The various embodiments relate generally to laser engraving and computer science and, more specifically, to a pattern editor for generating functional textures.

### Description of the Related Art

Laser engraving is a technique used to obtain a specific geometric pattern on a surface of a material via a focused laser beam. By injecting energy onto the surface using a focused laser beam, discrete locations on the surface are heated, and portions of the material are displaced and/or vaporized. Patterned surface geometries formed in this way can render a desired aesthetic texture on a workpiece and/or create a functional surface by forming geometric microstructures on a surface of the workpiece that alter the material properties of that surface. For example, and without limitation, certain laser-engraved microstructures can create surfaces that are low-friction, hydrophilic, hydrophobic, antibacterial, adhesive, self-cleaning, anti-corrosive, sound-absorbing, or capable of absorbing or reflecting specific frequencies of light.

Oftentimes, the required geometric features for a functional surface can be multiple orders of magnitude smaller than the diameter of a single laser pulse. For example, some functional surfaces include nanometer-scale features like crater lips, annealed metallic hairs or crystals, solidified splatter patterns, and/or condensed or deposited metallic dust or vapors, while the smallest laser spots available in laser-engraving systems are typically on the order of several microns in diameter. Consequently, many functional surfaces cannot be achieved by directly removing material from a workpiece to form the required geometric features. Instead, the required geometric features are typically achievable only by exploiting the secondary effects of the ablation that generally occurs during conventional laser-engraving, such as the chaotic scattering and/or annealing of material displaced when laser energy is injected into a given surface.

Ideally, computer simulations of the laser-engraving process could be employed when developing new functional surfaces, which would minimize or even eliminate the need for trial-and-error experimental approaches in determining the laser-engraving process parameters that create a particular functional surface. However, accurately characterizing how a series of laser pulses directed onto a given surface alters the geometry of that surface is a highly complex thermo-mechanical problem that requires high-resolution discretization in both space and time. Thus, any simulation of the thermo-mechanical effects of a single laser pulse on a particular surface can take minutes or even hours to execute. Further, the chaotic nature of the secondary effects of each laser pulse, as well as the perturbations caused by overlapping multiple laser pulses, can render accurate simulations impossible. As is well-understood, the mathematical complexity of chaotic dynamic systems generally cannot be accurately approximated with finite-element methods. As a result, conventional computer simulations have limited utility in laser-engraving processes.

In light of the above, new functional surfaces are usually created by the experimentally applying novel combinations of laser-engraving process parameters to a workpiece surface. Examples of various laser-engraving process parameters include, without limitation, the number of passes of a laser-engraving head over a workpiece surface, the different laser-pulse patterns used for each pass, and the laser-pulse energies used for each pass. Creating a specific functional surface based on the secondary effects of laser-engraving, as described above, typically requires the appropriate selection of these types of laser-engraving process parameters. The selected laser-engraving process parameters are then implemented for each pass of the laser-engraving head over a workpiece surface to create the desired functional surface. To implement the selected laser-engraving process parameters for each pass, the laser-engraving system has to be programmed accordingly. More specifically, for each pass of the laser-engraving head, the laser-engraving system is programmed to correctly position the laser-engraving head over the workpiece surface, control the motion of a laser-directing system, such as the mirrors of a galvanometer-based optical scanner, and precisely pulse the engraving laser at appropriate times and with appropriate pulse energies in coordination with the motion of the laser-directing system.

One drawback of the above approach is that conventional laser-engraving systems are configured for material removal and, as a result, provide limited user-selectable options for laser-pulse patterns to be implemented on a surface of a workpiece. For example, a conventional laser-engraving system removes material by scanning a laser across a workpiece surface along a series of parallel lines, where a user is able to select certain geometric parameters associated with the parallel lines, such as the separation between the lines and the spacing of laser pulses along the lines. However, positioning laser pulses in any pattern outside of the standard scanning scheme of parallel lines is generally not available to a user. As a result, implementing laser-engraving parameters when trying to create a desired functional surface usually involves manually programming the process parameters of the laser-engraving system, such as, and without limitation, laser power, pulse frequency, and engraving speed. Accordingly, not only does the conventional approach to experimentally creating a desired function surface take a substantial amount of time and labor, the user also has to be able to write code for the laser-engraving system and/or manually enter values for a laser-engraving process. A further drawback is that the user has to correctly determine the process parameters of the laser-engraving system that result in the laser pulses being delivered properly to targeted locations on the surface of the workpiece. Determining those process parameters can involve complex and time-consuming geometrical calculations. Thus, if the user calculates the values of the relevant process parameters incorrectly, then significant deviations from the intended laser-pulse pattern can occur, which can be difficult or impossible to detect.

As the foregoing illustrates, what is needed in the art are more effective ways to generate functional surfaces.

### SUMMARY

A computer-implemented method for generating laser engraving instructions for performing a patterning process on a workpiece surface includes receiving a first input value indicating a first laser-pulse pattern and a second input value for a laser parameter associated with a laser-engraving system; and generating a machine-command sequence for the laser-engraving system based on the first input value and the second input value.

At least one technical advantage of the disclosed techniques relative to the prior art is that the disclosed techniques enable specific laser-pulse patterns to be included automatically in laser-engraving processes used for generating a functional surface without having to manually program the laser-engraving parameters of any laser-engraving systems. A further advantage is that the intended laser-pulse pattern included in a laser-engraving process is automatically and reliably implemented by the laser-engraving system, even when the intended laser-pulse pattern varies from conventional patterns, such as a series of parallel lines of laser pulses. Accordingly, with the disclosed techniques, the effect of different laser-pulse patterns in combination with different laser parameter values can be systematically varied and evaluated in the course of generating one or more functional surfaces. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a functional-texture system configured to implement one or more aspects of the various embodiments.

FIG. 2A schematically illustrates a grid pattern that includes a plurality of spaced lines, according to various embodiments.

FIG. 2B schematically illustrates a grid pattern that includes a plurality of spaced lines, according to other various embodiments.

FIG. 2C schematically illustrates a grid pattern that includes a plurality of spaced curves, according to various embodiments.

FIG. 2D schematically illustrates a pattern that includes a plurality of spaced polylines, according to various embodiments.

FIG. 3 sets forth a flowchart of method steps for generating instructions for performing a laser-engraving process on a workpiece surface, according to various embodiments.

FIG. 4 sets forth a flowchart of method steps for generating a machine-command sequence for a laser-engraving system, according to various embodiments.

FIG. 5 is a block diagram of a computing device configured to implement one or more aspects of the various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

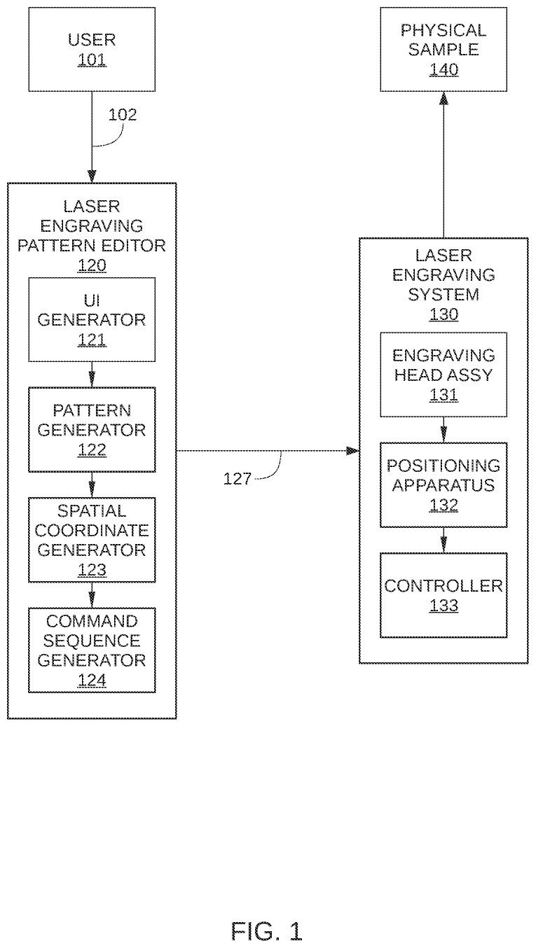

FIG. 1 illustrates a functional-texture system 100 configured to implement one or more aspects of the various embodiments. In the embodiment illustrated in FIG. 1, functional texture system 100 includes a laser-engraving pattern editor 120 and a laser-engraving system 130. Functional-texture system 100 is configured to generate a physical sample 140 of a potential functional texture, such as a functional surface formed on a surface of a workpiece (not shown). Laser-engraving pattern editor 120 is configured to generate a machine-command sequence 127 for controlling laser-engraving system 130 based on user inputs 102 from a user 101. Using machine-command sequence 127, laser-engraving system 130 then generates physical sample 140 of the prospective functional texture on a surface of a workpiece.

Laser-engraving system 130 can be any technically feasible system for performing laser-engraving on a workpiece. In some embodiments, laser-engraving system 130 includes an engraving head assembly 131, a positioning apparatus 132 for positioning engraving head assembly 131 with respect to a surface of a workpiece, and a controller 133. Positioning apparatus 132 can be any suitable multi-axis position device or assembly that locates and orients engraving head assembly 131 in two or three dimensions with respect to a workpiece. In operation, positioning apparatus 132 sequentially positions engraving head assembly 131 at different positions over the surface of the workpiece, so that discrete engraving regions can undergo laser engraving and have a final pattern formed thereon.

Engraving head assembly 131 is configured to generate physical sample 140 of a potential functional texture on a workpiece via a laser engraving process. In some embodiments, engraving head assembly 131 includes a laser source for generating suitable laser pulses and a mirror positioning system and laser optics to direct the pulses to specific locations within an engraving region. In such embodiments, controller 133 is configured to enable the operation of laser-engraving system 130, including controlling the components of engraving head assembly 131, so that laser pulses are directed to specified locations on a surface of a workpiece for a particular laser-engraving process. Thus, in some embodiments, controller 133 implements specific laser source and/or mirror positioning parameters so that a laser pulse of specified size and energy is directed to specified locations. Parameters for the laser source may include laser power, pulse frequency, and/or laser spot size, among others. Parameters for the movement of the laser beam with respect to the surface include engraving speed (e.g., the linear speed at which a laser spot moves across the surface being processed), laser incidence angle with respect to the surface being processed, and/or laser trajectory. In some embodiments, for a particular laser-engraving process, controller 133 is further configured to store predetermined locations and laser parameter values of laser pulses, and to implement various operations of a particular laser-engraving process so that the laser pulses are directed to such predetermined locations. According to various embodiments, controller 133 causes the various operations of the particular laser-engraving operation to be performed based on machine-command sequence 127 from laser-engraving pattern editor 120.

As noted above, laser-engraving pattern editor 120 generates machine-command sequence 127 for controlling laser-engraving system 130. According to various embodiments, laser-engraving pattern editor 120 generates machine-command sequence 127 based on user inputs 102, such as inputs provided by user 101 via a user interface associated with laser-engraving pattern editor 120. In some embodiments, user inputs 102 include one or more input values for parameters associated with a particular laser-engraving process. Thus, user inputs 102 enable a user to precisely define the particular laser-engraving process based on the variation of such parameters, for example to generate a specific instance of a functional surface on a workpiece. In the embodiments, such parameters can include one or more of an indicator of a particular laser-pulse pattern associated with the particular laser-engraving process, one or more geometric parameters associated with indicated laser-pulse patterns, and/or specific laser parameters associated with laser-engraving system 130. Examples of such parameters associated with a particular laser-engraving process are now described.

In some embodiments, user inputs 102 include one or more values for an indicator of a particular laser-pulse pattern associated with the particular laser-engraving process. In such embodiments, a different value indicates a different laser-pulse pattern that is associated with the particular laser-engraving process. Each laser-pulse pattern includes laser pulse locations associated with the particular laser-engraving process.

In some embodiments, user inputs 102 include multiple values indicating different laser-pulse patterns are associated with the particular laser-engraving process. In such embodiments, the particular laser-engraving process includes a number of laser passes (referred to herein as “phases”), where at least one laser-pulse pattern is applied to a surface of a workpiece in each phase. Thus, each phase of the laser-engraving process effectuates material removal from the workpiece via a different laser-pulse pattern.

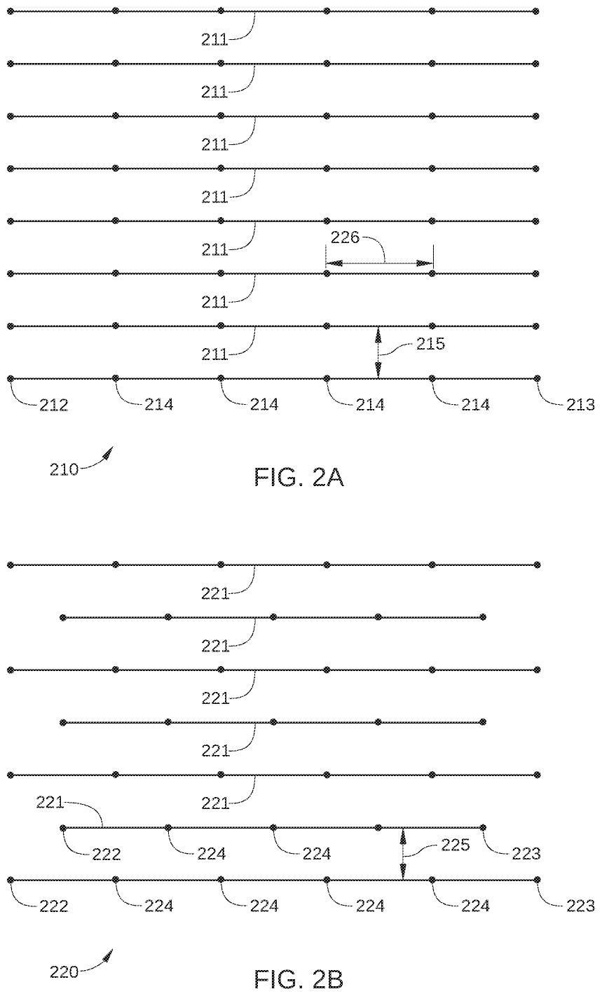

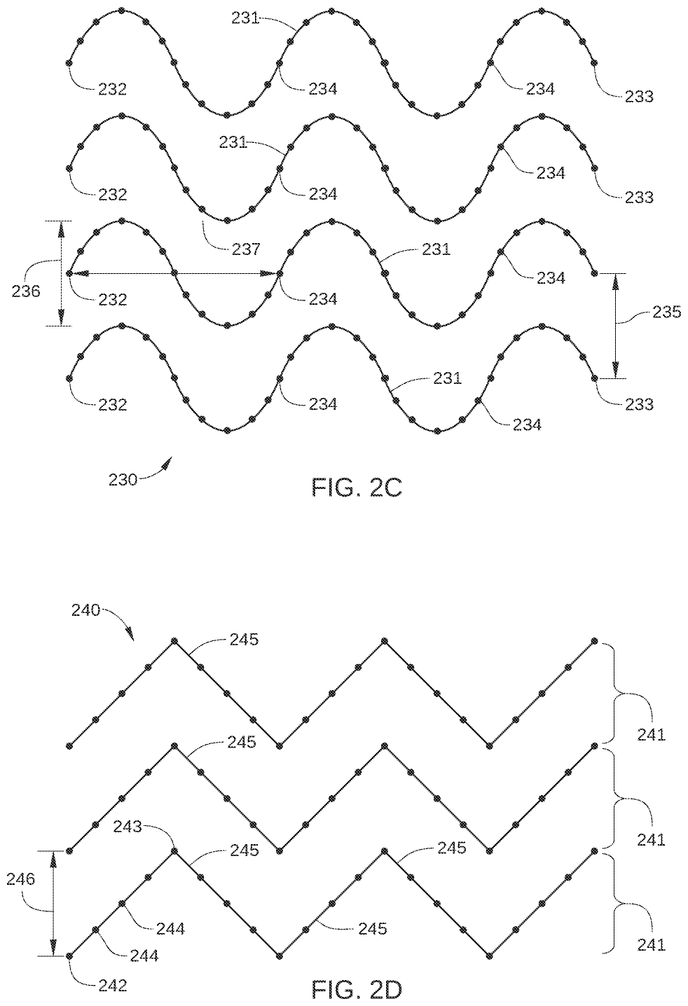

In some embodiments, the laser pulse locations of some laser-pulse patterns are based at least in part on geometric primitives included in the laser-pulse patterns. Examples of such laser-pulse patterns are described below in conjunction with FIGS. 2A-2D.

FIG. 2A schematically illustrates a grid pattern 210 that includes a plurality of spaced lines 211, according to various embodiments. In the embodiment illustrated in FIG. 2A, spaced lines 211 are parallel lines separated by a uniform spacing 215 as shown. In other embodiments, spaced lines 211 may be separated by nonuniform spacings (not shown), such as spacings that alternate between two or more values. In addition, each spaced line 211 includes a start point 212 and an end point 213 as shown. In some embodiments, a lasing sequence associated with a particular spaced line 211 of grid pattern 210 begins at start point 212 of the spaced line 211, ends at a corresponding end point 213 of the spaced line 211, and includes intermediate points 214 that are disposed along the spaced line 211. In such embodiments, each start point 212, end point 213, and intermediate point 214 corresponds to a different laser-pulse location included in the particular laser-engraving process that includes grid pattern 210. Thus, in the embodiment illustrated in FIG. 2A, the geometric primitives on which the laser pulse locations of grid pattern 210 are based include lines (e.g., spaced lines 211) and points (e.g., start points 212, end points 213, and intermediate points 214).

In the embodiment illustrated in FIG. 2A, intermediate points 214 are evenly distributed between start point 212 and end point 213, and are therefore separated by a spacing 216 that is uniform along a spaced line 211. In other embodiments, intermediate points 214 can be distributed in any other technically feasible way between start point 212 and end point 213. For example, in one such embodiment, spacing 216 varies along a spaced line 211, so that certain intermediate points 214 are separated by a first distance and other intermediate points 214 are separated a second distance. In another such embodiment, first groups of intermediate points 214 are separated from each other by a first distance, second groups of intermediate points 214 are separated from each other by a second distance, and the first and second groups of intermediate points 214 alternate with each other along a spaced line 213. In yet other embodiments, a spacing 216 associated with one spaced line 211 is different than a spacing 216 associated with an adjacent spaced line 211 in the same grid pattern 210.

FIG. 2B schematically illustrates a grid pattern 220 that includes a plurality of spaced lines 221, according to other various embodiments. Grid pattern 220 is similar to grid pattern 210 in FIG. 2A in that grid pattern 220 includes spaced lines 221 separated by a spacing 225, where spacing 225 can be uniform between all spaced lines 221 or vary between certain spaced lines 221. In addition, each spaced line 221 includes a start point 222, an end point 223, and multiple intermediate points 224 that are disposed along the spaced line 221. Further, the separation between such points may be either uniform or distributed in any technically feasible way between start point 222 and end point 223.

Unlike spaced lines 221 of grid pattern 210, some of spaced lines 221 of grid pattern 220 have offset locations for start point 222, the intermediate points 224, and/or the end point 223 relative to an adjacent spaced line 221. As a result, the laser-pulse locations included in grid pattern 220 form a grid that is not rectangular. For example, in the embodiment illustrated in FIG. 2B, the offset locations for the start points 222, the intermediate points 224, and the end points 223 of adjacent spaced lines 221 generate a hexagonal grid (depicted by dashed lines) of laser-pulse locations.

FIG. 2C schematically illustrates a pattern 230 that includes a plurality of spaced curves 231, according to various embodiments. In the embodiment illustrated in FIG. 2B, spaced curves 231 are separated by a uniform spacing 232 as shown. In other embodiments, spaced curves 231 may be separated by nonuniform spacings (not shown), such as spacings that alternate between two or more values. In addition, each spaced curve 231 includes a start point 232 and an end point 233, and multiple intermediate points 234 that are disposed along the spaced curve 231. Similar to the spaced lines 211 in FIG. 2A, in some embodiments, each start point 232, end point 233, and intermediate point 234 corresponds to a different laser-pulse location included in the particular laser-engraving process that includes pattern 230. Thus, in the embodiment illustrated in FIG. 2C, the geometric primitives on which the laser pulse locations of pattern 230 are based include curves (e.g., spaced curves 231) and points (e.g., start points 232, end points 233, and intermediate points 234).

In some embodiments, intermediate points 234 may be evenly distributed between start point 232 and end point 233, and therefore separated by a spacing 235 that is uniform, and in other embodiments, intermediate points 234 may be distributed in any other technically feasible way between start point 232 and end point 233. Further, in some embodiments, a spacing 235 associated with one spaced curve 231 is different than a spacing 235 associated with an adjacent spaced curve 231.

In some embodiments, some or all of spaced curves 231 are configured as sinusoidal waves. In such embodiments, each spaced curve 231 has a magnitude 236 and a wavelength 237. In some embodiments, magnitude 236 and/or wavelength 237 is uniform for all spaced curves 231 in pattern 230. In other embodiments, a magnitude 236 and/or a wavelength 237 for some spaced curves 231 in a pattern 230 differ from the magnitude 236 and/or wavelength 237 for other spaced curves 231 in the pattern 230. In yet other embodiments, some or all of spaced curves 231 are configured as some other repeating wave form than a sinusoidal waveform.

FIG. 2D schematically illustrates a pattern 240 that includes a plurality of spaced polylines 241, according to various embodiments. In the embodiment illustrated in FIG. 2D, each spaced polyline 241 includes a plurality of segments 245. Each segment 245 includes a start point 242 and an end point 243, and multiple intermediate points 244 that are disposed along the segment 245, and the separation between such points may be either uniform or distributed in any technically feasible way between start point 242 and end point 243. In some embodiments, a different lasing sequence is associated with each particular segment 245 of pattern 240, and begins at start point 242 of the segment 245, ends at a corresponding end point 243 of the segment 245, and includes intermediate points 244 that are disposed along the segment 245. In such embodiments, each start point 242, end point 243, and intermediate point 244 corresponds to a different laser-pulse location included in the particular laser-engraving process that includes pattern 240. Thus, in the embodiment illustrated in FIG. 2D, the geometric primitives on which the laser pulse locations of pattern 240 are based include polylines (e.g., polylines 241) and points (e.g., start points 242, end points 243, and intermediate points 244).

In some embodiments, all polylines 241 are separated by a uniform spacing 246 as shown. In other embodiments, polylines 241 may be separated by various spacings, such as a first spacing between some polylines 241 and a second spacing between other polylines 241. In such embodiments, polylines 241 separated by the first spacing may alternate in pattern 240 with polylines 241 separated by the second spacing. In addition, in some embodiments, segments 245 of polylines 241 may have different lengths and/or include a different number of intermediate points 244.

In some embodiments, an irregular (non-grid or non-repeating) pattern includes a configuration of stochastically determined laser-pulse locations. In such embodiments, the geometric primitives on which the laser pulse locations of the irregular pattern are based are randomly located points. In addition, in such embodiments, each laser-pulse location may be determined based on a random or pseudo-random spacing from proximate laser-pulse locations. In some embodiments, various probability distribution functions, such as Normal, Gamma, Weibull and others, can be employed for the generation of the random or pseudo-random spacings.

Returning to FIG. 1, in some embodiments, user inputs 102 include values for one or more geometric parameters associated with the indicated laser-pulse patterns of a particular laser-engraving process. Such user-selected values enable a user to adjust or modify each laser-pulse pattern that is indicated to be associated with a particular laser-engraving process. The geometric parameters associated with an indicated laser-pulse pattern vary depending on the specific laser-pulse pattern. For example, for a laser-pulse pattern that includes a plurality of spaced lines (e.g., grid pattern 210 in FIG. 2A or grid pattern 220 in FIG. 2B), associated geometric parameters may include one or more spacings between the spaced lines, one or more spacings between intermediate points along the spaced lines, offsets between starting points of the spaced lines, and/or the like. In another example, for a laser-pulse pattern that includes a plurality of spaced curves (e.g., pattern 230 in FIG. 2C), associated geometric parameters may include one or more spacings between the spaced curves, one or more spacings between intermediate points along the spaced curves, various curve parameters (e.g., magnitude and/or wavelength), and/or the like. In yet another example, for a laser-pulse pattern that includes a plurality of polylines (e.g., pattern 240 in FIG. 2D), associated geometric parameters may include one or more spacings between the polylines, one or more spacings between intermediate points along the polylines, various polyline parameters (e.g., segment length and/or segment slope), and/or the like. In yet another example, for a laser-pulse pattern that includes a configuration of stochastically determined laser-pulse locations, associated geometric parameters may include an indicator of a specific probability distribution that is employed for determining spacings between laser-pulse locations, and/or parameters associated with such a probability distribution, such as a mean separation distance, a separation distance standard deviation, etc.

In embodiments in which a laser-engraving process includes multiple phases, user inputs 102 can include values for geometric parameters indicating a relationship between a grid pattern associated with one phase of the laser-engraving process and a grid pattern associated with another phase of the laser-engraving process.

In some embodiments, the relationship between the grid patterns associated with different phases of the laser-engraving process includes an offset angle between the grid patterns. For example, in an embodiment in which a laser-engraving process includes a first phase with a first grid pattern of parallel lines and a second phase with a second grid pattern of parallel lines, user inputs 102 can include a value indicating an offset angle between the parallel lines of the first grid pattern and the parallel lines of the second grid pattern. Thus, for a value of 90 degrees of offset angle, the first grid pattern and the second grid pattern produce a square or rectangular grid pattern of laser-pulse locations. In another example, a laser-engraving process includes a first phase with a first grid pattern of parallel lines, a second phase with a second grid pattern of parallel lines, and a third phase with a third grid pattern of parallel lines. In such an embodiment, for a value of 60 degrees of offset angle between the first and second grid patterns and between the second and third grid patterns, the combination of the first, second, and third grid patterns produces a hexagonal grid pattern of laser-pulse locations.

In some embodiments, the relationship between the grid patterns associated with different phases of the laser-engraving process includes a linear offset between the grid patterns. For example, in an embodiment in which a laser-engraving process includes a first phase with a first grid pattern of parallel lines and a second phase with a second grid pattern of parallel lines, user inputs 102 can include a value indicating a vertical or horizontal offset distance between the parallel lines of the first grid pattern and the parallel lines of the second grid pattern. Thus, with appropriate vertical and horizontal offsets, the combination of the first grid pattern and the second grid pattern can produce a pattern of laser-pulse locations with offset parallel lines similar to grid 220 in FIG. 2B. Further, the application of vertical and/or horizontal offset values between different grid patterns can produce many other more complicated patterns of laser-pulse locations via the combination of multiple simple grid patterns.

In some embodiments, an offset angle and/or a linear offset of position between multiple phases of a laser-engraving process are indicated by an Affine matrix. Additionally or alternatively, in some embodiments, scaling between multiple phases of a laser-engraving process and/or skew between multiple phases of a laser-engraving process are indicated by an Affine matrix.

In some embodiments, user inputs 102 include values for one or more specific laser parameters associated with laser-engraving system 130. In such embodiments, such laser-pulse parameters may include a laser power, a laser light frequency, and/or a laser spot size, among others. In some embodiments, one or more such laser-pulse parameters are varied for different phases of a single laser-engraving process. Thus, in such embodiments, one or more laser-pulse parameters can be varied for each laser-pulse pattern included in the laser-engraving process.

Laser-engraving pattern editor 120 includes one or more of a user interface (UI) generator 121, a pattern generator 122, a spatial coordinate generator 123, and a command sequence generator 124. UI generator 121 generates a UI (not shown) to facilitate entry of user inputs 102 by user 101 for a particular laser-engraving process. In some embodiments, options provided to user 101 via the UI are a function of previous entries made for the laser-engraving process, such as the type of pattern(s) selected by user 101 to be included in the laser-engraving process, the number of phases selected by user 101 to be included in the laser-engraving process, etc. Pattern generator 122 generates a set of geometric primitives, such as lines, curves, points, polylines, etc., for the particular laser-engraving process. The set of geometric primitives is based on the patterns indicated in user inputs 102 and on the values for geometric parameters included in user inputs 102. In instances in which the laser-engraving process includes multiple phases, pattern generator 122 generates a set of geometric primitives for each phase. Spatial coordinate generator 123 generates spatial coordinates of the geometric primitives generated by pattern generator 122, so that the geometric primitives are arranged according to the geometric parameters of the associated pattern. Command sequence generator 124 generates a machine-command sequence for the particular laser-engraving process based on the spatial coordinates generated by spatial coordinate generator 123 and on the values for laser parameters included in user inputs 102. The machine-command sequence so generated is readable by laser-engraving system 130, and includes one or more laser-engraving coordinates and laser settings for each geometric primitive included in each phase of the laser-engraving process.

### Pattern Editing for a Laser-Engraving Process

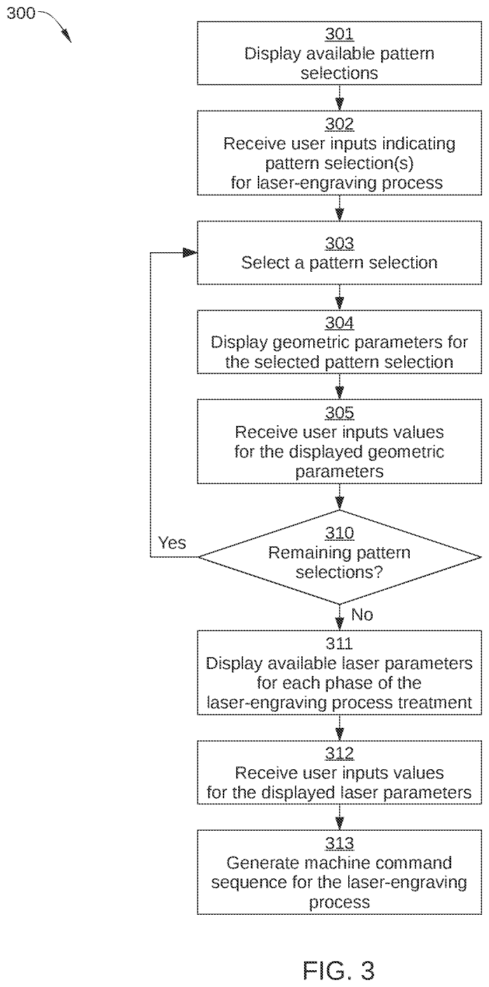

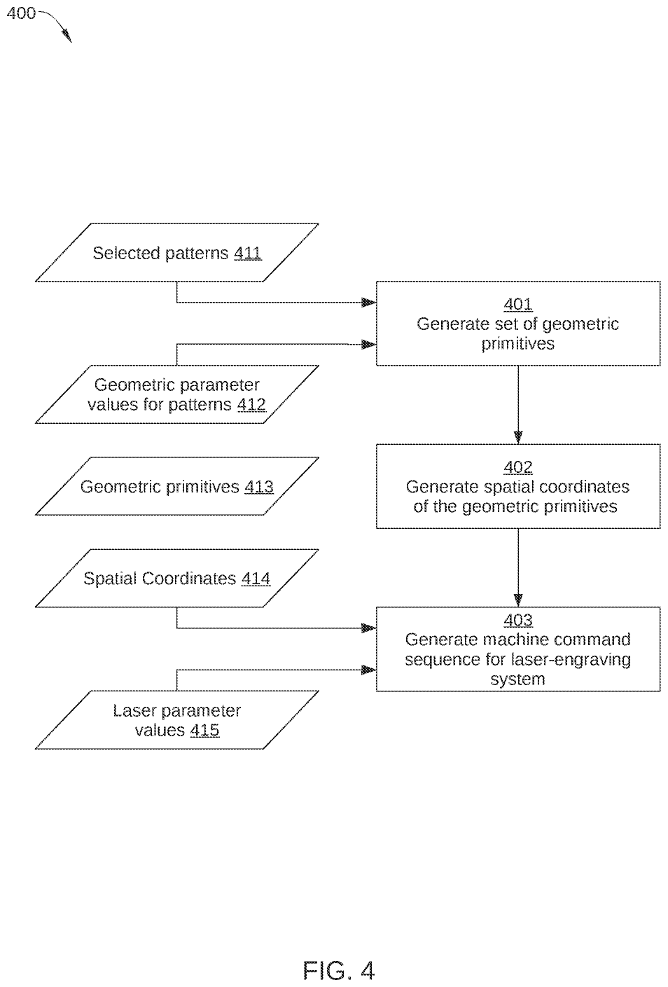

According to various embodiments, a user generates and edits a laser-engraving process with functional texture system 100. For example, user 101 can edit a laser-engraving process for potentially generating a functional surface. As described above, user 101 provides user inputs 102 via laser-engraving pattern editor 120, where user inputs 102 include values for high-level parameters, such as the selection of specific laser-pulse patterns and the adjustment of the geometric parameters of such a pattern. Thus, entry of low-level engraving system commands, such as specific laser-steering commands and laser-pulse frequencies, are not required for user 101 to modify and/or create different laser-pulse patterns. One such embodiment is described below in conjunction with FIGS. 3 and 4.

FIG. 3 sets forth a flowchart of method steps for generating instructions for performing a laser-engraving process on a workpiece surface, according to various embodiments. Although the method steps are described in conjunction with the system of FIG. 1, persons skilled in the art will understand that any system configured to perform the method steps, in any order, is within the scope of the embodiments.

As shown, a method 300 begins at step 301, where functional-texture system 100 displays available pattern selections to user 101, for example via a UI generated by UI generator 121. In some embodiment, categories of available pattern selections include a grid pattern of spaced lines, a wave pattern of spaced curves, and/or a stochastic pattern of random or pseudo-random laser-pulse locations.

In step 302, functional-texture system 100 receives user inputs 102, for example via the UI generated by UI generator 121. Generally, user inputs 102 include one or more values indicating specific pattern selections. In addition, in some embodiments, user inputs 102 further include values indicating a number of phases that are associated with the current laser-engraving process and which pattern selections correspond to which phase.

In step 303, functional-texture system 100 selects one of the pattern selections indicated in user inputs 102. In step 304, functional-texture system 100 displays geometric parameters for the selected pattern selection, for example via the UI generated by UI generator 121. Such geometric parameters include line spacings, point spacings, offset angles and distances between different patterns, and/or the like. In step 305, functional-texture system 100 receives user inputs 102 for the selected pattern selection, where user inputs 102 include one or more values for the geometric parameters displayed in step 304.

In step 310, functional-texture system 100 determines whether there are any remaining pattern selections that have geometric parameters for which user inputs 102 are required. If yes, method 300 returns to step 303 and a remaining pattern selection is selected; if no, method 300 proceeds to step 311.

In step 311, functional-texture system 100 displays available laser parameters for each phase of the laser-engraving process, for example via a UI generated by UI generator 121. In some embodiments, such laser parameters are associated with individual laser pulses or trains of laser pulses, such as laser power and/or laser spot size. In such embodiments, the displayed laser parameters do not include laser source parameters that affect the location of laser pulses, such as laser pulse frequency, since user 101 indicates locations of specific laser pulses directly, for example via pattern selection and adjustment.

In step 312, functional-texture system 100 receives user inputs 102, for example via the UI generated by UI generator 121. Generally, user inputs 102 include one or more values for the laser parameters displayed in step 311.

In step 313, functional-texture system 100 generates a machine-command sequence for the laser-engraving process edited by user 101. As noted, the machine-command sequence so generated is readable by laser-engraving system 130, and includes one or more laser-engraving coordinates and laser settings for each geometric primitive included in each phase of the laser-engraving process. One embodiment of the generation of such a machine-command sequence is described below in conjunction with FIG. 4.

FIG. 4 sets forth a flowchart of method steps for generating a machine-command sequence for a laser-engraving system, according to various embodiments. Although the method steps are described in conjunction with the system of FIG. 1, persons skilled in the art will understand that any system configured to perform the method steps, in any order, is within the scope of the embodiments.

As shown, a method 400 begins at step 401, where functional-texture system 100 generates a set of geometric primitives 413 for each phase of a laser-engraving process, such as the laser-engraving process edited in method 300 of FIG. 3. In some embodiments, pattern generator 122 generates geometric primitives 413, such as lines, points, curves, and/or polylines. Pattern generator 122 generates the geometric primitives for a phase of the laser-engraving process based on the laser-pulse pattern or patterns 411 selected for that phase and on the geometric parameter values 412 for the selected laser-pulse patterns. For example, based on a laser-pulse pattern that includes a series of repeating polylines, pattern generator 122 generates lines based on the segments of each polyline and points based on the starting points, intermediate points, and end points of the segments.

In step 402, functional-texture system 100 generates spatial coordinates 414 of geometric primitives 413 generated in step 401, for example via spatial coordinate generator 123. Spatial coordinates 414 are determined according to the geometric parameters of the associated pattern. Because a surface on which the laser-engraving process is performed may not be a flat plane, spatial coordinates 414 can be three-dimensional coordinates. In some embodiments, for each separate point included in geometric primitives 413, spatial coordinate generator 123 determines a three-dimensional location for the point. Similarly, for each line segment or curve included in geometric primitives 413, spatial coordinate generator 123 determines a three-dimensional location for a start point and an end point.

In step 403, functional-texture system 100 generates a machine-command sequence for laser-engraving system 130, for example via command sequence generator 124. Command sequence generator 124 generates the machine-command sequence based on spatial coordinates 414 and on laser parameter values 415 included in user inputs 102.

For example, in some embodiments, for a line segment included in geometric primitives 413, command sequence generator 124 generates a laser setting command and two laser steering commands. The laser setting command sets laser parameters of laser-engraving system 130 to the laser parameter values 415 included in user inputs 102, so that a laser source starts lasing at an appropriate time (e.g., when the laser source is directed to a starting point of the line segment), pulse frequency, and power, and ends lasing at an appropriate time (e.g., when the laser source is directed to an ending point of the line segment). The laser steering commands cause a mirror positioning system and laser optics of engraving head assembly 131 to direct laser pulses generated by the laser source to specific locations on a workpiece surface. Together, the laser setting command and the laser steering commands cause laser pulses to be directed to the laser-pulse locations indicated by user 101 via user inputs 102.

In another example, for a single point included in geometric primitives 413, command sequence generator 124 generates a laser setting command and a single laser steering command. In the example, the laser steering command causes a mirror positioning system and laser optics of engraving head assembly 131 to direct a specific laser pulse to the specific laser-pulse location associated with the point.

In some embodiments, after generating the machine-command sequence for laser-engraving system 130, command sequence generator 124 converts the machine-command sequence into a binary format associated with laser-engraving system 130. Generally, such a binary format is a vendor-specific format that is readable by controller 133 and/or other control systems of laser-engraving system 130. Thus, based on values included in user inputs 102, laser-engraving editor 120 generates a machine-command sequence for laser engraving system 130 that implements a laser engraving process associated with the input values of user inputs 102. It is noted that user 101 does not enter specific laser-steering commands or commands for the timing or frequency of laser pulses, and instead enters values that directly describe a targeted laser-pulse pattern.

### Exemplary Computing Device

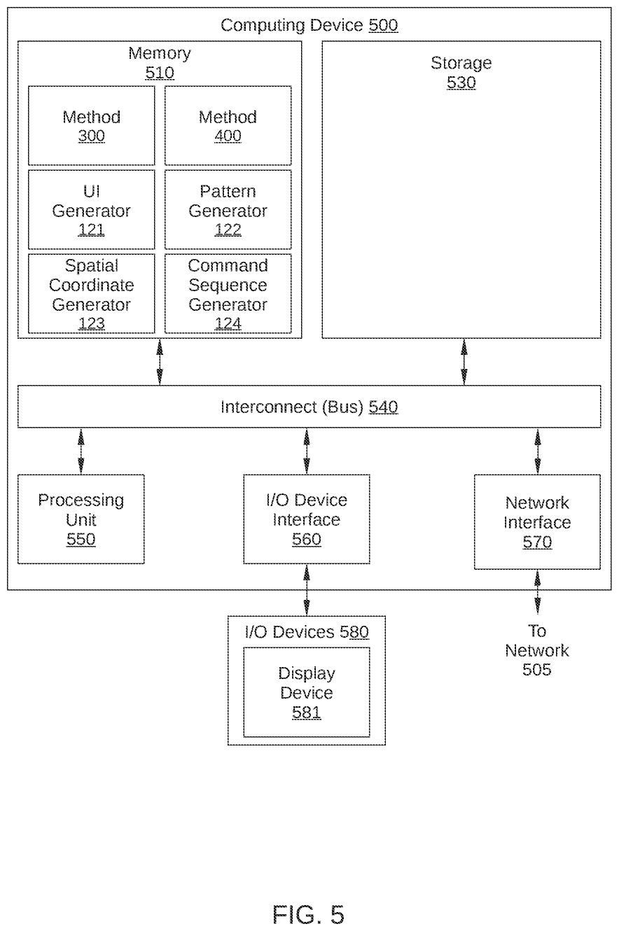

FIG. 5 is a block diagram of a computing device 500 configured to implement one or more aspects of the various embodiments. Thus, computing device 500 can be a computing device associated with functional texture system 100 and/or controller 133. Computing device 500 may be a desktop computer, a laptop computer, a tablet computer, or any other type of computing device configured to receive input, process data, generate control signals, and display images. Computing device 500 is configured to perform operations associated with method 300, method 400, UI generator 121, pattern generator 122, spatial coordinate generator 123, command sequence generator 124, and/or other suitable software applications, which can reside in a memory 510. It is noted that the computing device described herein is illustrative and that any other technically feasible configurations fall within the scope of the present disclosure.

As shown, computing device 500 includes, without limitation, an interconnect (bus) 540 that connects a processing unit 550, an input/output (I/O) device interface 560 coupled to input/output (I/O) devices 580, memory 510, a storage 530, and a network interface 570. Processing unit 550 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processing unit 550 may be any technically feasible hardware unit capable of processing data and/or executing software applications, including processes associated with method 300, method 400, UI generator 121, pattern generator 122, spatial coordinate generator 123, and/or command sequence generator 124. Further, in the context of this disclosure, the computing elements shown in computing device 500 may correspond to a physical computing system (e.g., a system in a data center) or may be a virtual computing instance executing within a computing cloud.

I/O devices 580 may include devices capable of providing input, such as a keyboard, a mouse, a touch-sensitive screen, and so forth, as well as devices capable of providing output, such as a display device 581. Additionally, I/O devices 580 may include devices capable of both receiving input and providing output, such as a touchscreen, a universal serial bus (USB) port, and so forth. I/O devices 580 may be configured to receive various types of input from an end-user of computing device 500, and to also provide various types of output to the end-user of computing device 500, such as one or more graphical user interfaces (GUI), displayed digital images, and/or digital videos. In some embodiments, one or more of I/O devices 580 are configured to couple computing device 500 to a network 505.

Memory 510 may include a random access memory (RAM) module, a flash memory unit, or any other type of memory unit or combination thereof. Processing unit 550, I/O device interface 560, and network interface 570 are configured to read data from and write data to memory 510. Memory 510 includes various software programs that can be executed by processor 550 and application data associated with said software programs, including method 300, method 400, UI generator 121, pattern generator 122, spatial coordinate generator 123, and/or command sequence generator 124.

In sum, the various embodiments described herein provide techniques for generating laser-engraving instructions for a laser-engraving system to perform a laser-engraving process on a surface. In the embodiments, a machine-command sequence for the laser-engraving system is generated based on user inputs indicating one or more specific laser-pulse patterns and values for geometric parameters of such patterns.

At least one technical advantage of the disclosed techniques relative to the prior art is that the disclosed techniques enable a user to cause a specific laser-pulse pattern to be included in a laser-engraving process without manually configuring discrete values for laser-engraving parameters of the laser-engraving system. A further advantage is that the intended laser-pulse pattern a user includes in a laser-engraving process is reliably implemented by the laser-engraving system, even when the intended laser-pulse pattern varies from conventional user-selectable patterns, such as rows of parallel lines of laser pulses. Accordingly, with the disclosed techniques, the effect of different laser-pulse patterns in combination with different laser parameter values can be systematically varied and evaluated with respect to generating different functional surfaces. These technical advantages provide one or more technological advancements over prior art approaches.

1. In some embodiments, a computer-implemented method for generating laser engraving instructions for performing a patterning process on a workpiece surface includes: receiving a first input value indicating a first laser-pulse pattern and a second input value for a laser parameter associated with a laser-engraving system; and generating a machine-command sequence for the laser-engraving system based on the first input value and the second input value.

2. The computer-implemented method of clause 1, further comprising receiving a third input value for a geometric parameter associated with the first laser-pulse pattern, wherein the machine-command sequence is generated based on the third input value as well.

3. The computer-implemented method of clause 1 or 2, wherein the geometric parameter comprises a number of laser-engraving phases included in the patterning process, a spacing between lines included in the first laser-pulse pattern, an offset distance between a first line associated with a first laser-engraving phase included in the patterning process and a second line associated with a second laser-engraving phase included in the patterning process, or an offset angle between the first line and the second line.

4. The computer-implemented method of any of clauses 1-3, wherein the first laser-pulse pattern comprises a grid pattern that includes multiple lines, a grid pattern that includes multiple curves, a grid pattern that includes multiple polylines, or a grid pattern that includes multiple stochastically determined laser-pulse locations.

5. The computer-implemented method of any of clauses 1-4, further comprising, converting the machine-command sequence into a binary format recognizable by the laser-engraving system.

6. The computer-implemented method of any of clauses 1-5, wherein the machine-command sequence, when executed by the laser-engraving system, causes the laser-engraving system to perform the patterning process on the workpiece surface.

7. The computer-implemented method of any of clauses 1-6, further comprising, determining a set of geometric primitives associated with the first laser-pulse pattern.

8. The computer-implemented method of any of clauses 1-7, wherein the set of geometric primitives includes at least one of multiple points, multiple lines, multiple curves, or multiple polylines.

9. The computer-implemented method of any of clauses 1-8, wherein generating the machine-command sequence comprises determining, for each line included in the geometric primitives, a first laser-steering command that indicates a start point at which a lasing sequence begins and a second laser-steering command that indicates an end point at which a lasing sequence ends.

10. The computer-implemented method of any of clauses 1-9, further comprising, based on the set of geometric primitives, generating a set of spatial coordinates for each laser pulse location associated with the set of geometric primitives.

11. A non-transitory computer readable medium storing instructions that, when executed by a processor, cause the processor to perform the steps of: receiving a first input value indicating a first laser-pulse pattern and a second input value for a laser parameter associated with a laser-engraving system; and generating a machine-command sequence for the laser-engraving system based on the first input value and the second input value.

12. The non-transitory computer readable medium of clause 11, storing instructions that, when executed by a processor, cause the processor to perform the step of receiving a third input value for a geometric parameter associated with the first laser-pulse pattern, wherein the machine-command sequence is generated based on the third input value as well.

13. The non-transitory computer readable medium of clause 11 or 12, wherein the geometric parameter comprises a number of laser-engraving phases included in the patterning process, a spacing between lines included in the first laser-pulse pattern, an offset distance between a first line associated with a first laser-engraving phase included in the patterning process and a second line associated with a second laser-engraving phase included in the patterning process, or an offset angle between the first line and the second line.

14. The non-transitory computer readable medium of any of clauses 11-13, wherein the first laser-pulse pattern comprises a grid pattern that includes multiple lines, a grid pattern that includes multiple curves, a grid pattern that includes multiple polylines, or a grid pattern that includes multiple stochastically determined laser-pulse locations.

15. The non-transitory computer readable medium of any of clauses 11-14, storing instructions that, when executed by a processor, cause the processor to perform the steps of converting the machine-command sequence into a binary format recognizable by the laser-engraving system.

16. The non-transitory computer readable medium of any of clauses 11-15, wherein the machine-command sequence, when executed by the laser-engraving system, causes the laser-engraving system to perform the patterning process on the workpiece surface.

17. The non-transitory computer readable medium of any of clauses 11-16, storing instructions that, when executed by a processor, cause the processor to perform the steps of receiving a third input value indicating a first laser-engraving phase and a second laser-engraving phase of the patterning process.

18. The non-transitory computer readable medium of any of clauses 11-17, further comprising receiving a fourth input value indicating that the first laser-pulse pattern is associated with the first laser-engraving phase and a second laser-pulse pattern is associated with the second laser-engraving phase.

19. The non-transitory computer readable medium of any of clauses 11-18, wherein the machine-command sequence includes a spatial coordinate and a laser parameter value for each laser-pulse location included in the first laser-pulse pattern.

20. A system, comprising: a memory that stores instructions; and a processor that is communicatively coupled to the memory and is configured to, when executing the instructions, perform the steps of: receiving a first input value indicating a first laser-pulse pattern and a second input value for a laser parameter associated with a laser-engraving system; and generating a machine-command sequence for the laser-engraving system based on the first input value and the second input value.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating laser engraving instructions for performing a patterning process on a workpiece surface, the method comprising:
receiving a first input value indicating a first laser-pulse pattern and a second input value for a laser parameter associated with a laser-engraving system; and
generating a machine-command sequence for the laser-engraving system based on the first input value and the second input value.

2. The computer-implemented method of claim 1, further comprising receiving a third input value for a geometric parameter associated with the first laser-pulse pattern, wherein the machine-command sequence is generated based on the third input value as well.

3. The computer-implemented method of claim 2, wherein the geometric parameter comprises a number of laser-engraving phases included in the patterning process, a spacing between lines included in the first laser-pulse pattern, an offset distance between a first line associated with a first laser-engraving phase included in the patterning process and a second line associated with a second laser-engraving phase included in the patterning process, or an offset angle between the first line and the second line.

4. The computer-implemented method of claim 1, wherein the first laser-pulse pattern comprises a grid pattern that includes multiple lines, a grid pattern that includes multiple curves, a grid pattern that includes multiple polylines, or a grid pattern that includes multiple stochastically determined laser-pulse locations.

5. The computer-implemented method of claim 1, further comprising, converting the machine-command sequence into a binary format recognizable by the laser-engraving system.

6. The computer-implemented method of claim 1, wherein the machine-command sequence, when executed by the laser-engraving system, causes the laser-engraving system to perform the patterning process on the workpiece surface.

7. The computer-implemented method of claim 1, further comprising, determining a set of geometric primitives associated with the first laser-pulse pattern.

8. The computer-implemented method of claim 7, wherein the set of geometric primitives includes at least one of multiple points, multiple lines, multiple curves, or multiple polylines.

9. The computer-implemented method of claim 8, wherein generating the machine-command sequence comprises determining, for each line included in the geometric primitives, a first laser-steering command that indicates a start point at which a lasing sequence begins and a second laser-steering command that indicates an end point at which a lasing sequence ends.

10. The computer-implemented method of claim 7, further comprising, based on the set of geometric primitives, generating a set of spatial coordinates for each laser pulse location associated with the set of geometric primitives.

11. A non-transitory computer readable medium storing instructions that, when executed by a processor, cause the processor to perform the steps of:
receiving a first input value indicating a first laser-pulse pattern and a second input value for a laser parameter associated with a laser-engraving system; and
generating a machine-command sequence for the laser-engraving system based on the first input value and the second input value.

12. The non-transitory computer readable medium of claim 11, storing instructions that, when executed by a processor, cause the processor to perform the step of receiving a third input value for a geometric parameter associated with the first laser-pulse pattern, wherein the machine-command sequence is generated based on the third input value as well.

13. The non-transitory computer readable medium of claim 12, wherein the geometric parameter comprises a number of laser-engraving phases included in the patterning process, a spacing between lines included in the first laser-pulse pattern, an offset distance between a first line associated with a first laser-engraving phase included in the patterning process and a second line associated with a second laser-engraving phase included in the patterning process, or an offset angle between the first line and the second line.

14. The non-transitory computer readable medium of claim 11, wherein the first laser-pulse pattern comprises a grid pattern that includes multiple lines, a grid pattern that includes multiple curves, a grid pattern that includes multiple polylines, or a grid pattern that includes multiple stochastically determined laser-pulse locations.

15. The non-transitory computer readable medium of claim 11, storing instructions that, when executed by a processor, cause the processor to perform the steps of converting the machine-command sequence into a binary format recognizable by the laser-engraving system.

16. The non-transitory computer readable medium of claim 11, wherein the machine-command sequence, when executed by the laser-engraving system, causes the laser-engraving system to perform the patterning process on the workpiece surface.

17. The non-transitory computer readable medium of claim 11, storing instructions that, when executed by a processor, cause the processor to perform the steps of receiving a third input value indicating a first laser-engraving phase and a second laser-engraving phase of the patterning process.

18. The non-transitory computer readable medium of claim 17, further comprising receiving a fourth input value indicating that the first laser-pulse pattern is associated with the first laser-engraving phase and a second laser-pulse pattern is associated with the second laser-engraving phase.

19. The non-transitory computer readable medium of claim 11, wherein the machine-command sequence includes a spatial coordinate and a laser parameter value for each laser-pulse location included in the first laser-pulse pattern.

20. A system, comprising:
a memory that stores instructions; and
a processor that is communicatively coupled to the memory and is configured to, when executing the instructions, perform the steps of:
receiving a first input value indicating a first laser-pulse pattern and a second input value for a laser parameter associated with a laser-engraving system; and
generating a machine-command sequence for the laser-engraving system based on the first input value and the second input value.
